(19) United States
(12) Patent Application Publication
(10) Pub. No.: US 2013/0046562 A1
(43) Pub. Date: Feb. 21, 2013

(54) METHOD FOR GATHERING, PROCESSING, AND ANALYZING DATA TO DETERMINE THE RISK ASSOCIATED WITH DRIVING BEHAVIOR

(71) Applicants: Jeffrey Taylor, West Valley City, UT (US); Xuesong Zhou, Sandy, UT (US); MIchael W. Fahnert, Lindon, UT (US); Eric J. Bowden, West Jordan, UT (US)

(72) Inventors: Jeffrey Taylor, West Valley City, UT (US); Xuesong Zhou, Sandy, UT (US); MIchael W. Fahnert, Lindon, UT (US); Eric J. Bowden, West Jordan, UT (US)

(21) Appl. No.: 13/508,941

(22) PCT Filed: Nov. 8, 2010
(86) PCT No.: PCT/US10/55872

§ 371 Date: Aug. 6, 2012

Related U.S. Application Data
(60) Provisional application No. 61/258,850, filed on Nov. 6, 2009.

(51) Int. Cl. G06Q 40/08

(52) U.S. Cl. 705/4

(57) ABSTRACT

A system and method for gathering, processing, and analyzing data to determine the risk associated with driving behavior is disclosed. A crash risk factor can be assigned to a driver behavior in a database (710), where the crash risk factor has a value related to a crash scenario. The crash scenario can be a crash type or a crash severity. A trip length input for the vehicle can be received from a sensor (720). The trip length input can be a distance traveled for the trip or a time duration for the trip. The trip length can be segmented into a plurality of intervals. The interval can be a distance segment of the trip or a time segment of the trip. The sensor can either be an integrated vehicle sensor integrated with the vehicle or a portable sensor contained in the vehicle. The portable sensor contained in the vehicle can be a mobile phone or other mobile communication device. The integrated vehicle sensor can be an on-board sensor that is configured to communicate with the portable wireless device. A base-line value for the crash risk factor for each interval of the trip can be determined (730) where the base-line value represents a value for safe driving without the crash risk factor. The occurrence of driver behavior corresponding to the crash risk factor for each interval can be determined. A crash risk mileage value for each interval of the trip can be calculated (740) by multiplying the base-line value by an interval length and the crash risk factor applicable to the interval. A total crash risk mileage value for the trip can be determined by combining (750) the crash risk mileage value for each interval. At least one of the total crash risk mileage value and the driver behavior for the trip can be transmitted (760) to a remote server with a mobile communication device to allow driver behavior-related risk to be analyzed.

### BACKGROUND

Although there is sufficient data to prove that driving distractions, including texting while driving and talking on the phone while driving, increase the risk of collision involvement, estimating the resulting insurance cost for a driver has been difficult because the exact number of crashes caused by cell phone use are unknown and the personal data on cell phone use while driving is typically unavailable. Several researchers have attempted to quantify the total societal cost of crashes caused by cell phone use, but it is challenging to gather, process, and analyze the data from multiple sources and estimate the associated risk and insurance cost for individual drivers. Similar efforts have been spent attempting to determine insurance costs, particularly through pay-as-you-go insurance policies or distance-based insurance policies.

Many insurance companies currently use a combination of demographical information, mileage, driving record, and credit history among others to determine a driver's insurance rate premium. Each insurance organization may use a different method in which some information is used in rate determination and some information is not used. In addition, the type of information gathered can provide an indirect assessment of a driver's risk where the statistical relationship shows a correlation between demographics and claim filing. The insurance company doesn't have precise information about how risky an individual driver's behavior is when they are behind the wheel, so only a rough estimate based on population statistics can be used to determine an insurance rate.

### SUMMARY

A system and method for gathering, processing, and analyzing data to determine crash risk associated with driving behavior is disclosed. The system can comprise an on-board data collection device on a vehicle, a cell phone application to block or monitor phone use, a data server, and a risk assessment application using a risk assessment method for determining the risk associated with an individual's driving behavior. The data collection device can be an On-Board Diagnostic [OBD] device or GPS location data collection device that can collect information about driver behavior. A cell phone application installed on the driver's phone can gather information about the phone's location and use while the driver is driving to gather information about phone use while the driver is driving and process, store, or transmit the collected data. A data server can process the collected data from the risk assessment method for estimating the crash risk associated with individual driving behavior. The collected and calculated data from the method can be stored by the data server.

An on-board data collection device can be used to collect data from the vehicle which can include vehicle ignition, speed, mileage traveled, and seat belt use. Based on location data and timestamp data collected from a GPS device, speed, acceleration and deceleration measures can be calculated, or the on-board data collection device can provide this data directly. The on-board data collection device can transmit collected data via wireless connection to the driver's cell phone with the specific application installed on the phone or the on-board data collection device. The phone application can be used to block or monitor incoming and outgoing calls and text messages while the vehicle is operating, and can remove a block and collect phone use data when emergency communication is initiated through the phone application. The collected data can then be organized and processed through a trip profile to estimate the crash risk to the driver due to the driver's behavior behind the wheel. The data organizing and processing performed in the trip profile may occur at the driver's cell phone or at a centralized data server. Either raw collected data or processed data can be communicated by text messages from the driver's cell phone to a centralized data server for processing or storage. Alternatively, the data can be sent to the server by other message formats or communication channels.

The crash risk assessment method and system can calculate the total crash risk to the driver in relation to the distance traveled per trip, referred to as “risk mileage”. Alternatively, the total crash risk can be calculated in relation to the time duration of the trip. Risk mileage can be the equivalent distance traveled to accumulate the same level of risk had no unsafe behavior considered in the risk assessment model taken place. In other words, the risk mileage can be roughly equivalent to the actual trip miles plus penalty miles associated with risky behavior in terms of total risk exposure. The risk assessment system calculates the risk mileage from each trip using risk factors, mileage data, speed data, and behavioral data for multiple crash severities (i.e., fatal, injury, property damage only [PDO]) and accumulates the risk mileage from each trip over a period of time (i.e. a month or a year) in order to determine the total crash risk exposure over that time period. Risk mileage can be used as a common driver performance measurement as part of an open, universal, transparent insurance rate determination system based on individual driving behavior and driving distance or duration. The risk mileage allows drivers to view their own behavioral records and examine how their behavior influences their vehicle insurance rates, as well as provide common data for insurance underwriters to compare drivers and perform actuarial analysis.

### BRIEF DESCRIPTION OF THE DRAWINGS

Features and advantages of the invention will be apparent from the detailed description which follows, taken in conjunction with the accompanying drawings, which together illustrate, by way of example, features of the invention; and, wherein:

FIG. 1 is an exemplary illustration of a trip profile used to calculate the risk mileage for the trip;

FIG. 2 is a flow chart depicting driver behavior as a factor in vehicle collision and collision severity in relation to other pertinent factors, data handling after collection of the factors, calculations of the factors, and inputs and outputs in accordance with an example;

FIG. 3 is a flow chart depicting a data collection architecture employed to communicate speed, mileage, phone use, and other data through a cell phone or similar mobile computing device in accordance with an example;

FIG. 4 is a flow chart depicting the risk mileage calculation for one trip in accordance with an example;

FIG. 5 is a flow chart depicting the baseline calibration process for crash types in accordance with an example;

FIG. 6A is illustration of a scoring model used to communicate relative risk levels to drivers, insurance companies, or underwriters in accordance with an example;

FIG. 6B is an illustration of a scoring model used to communicate relative risk levels to drivers, insurance companies, or underwriters in accordance with an example; and

FIG. 7 is a flowchart illustrating a method for quantifying driver behavior-related crash risk for a trip in a vehicle in accordance with an example.

Reference will now be made to the examples illustrated, and specific language will be used to describe the examples. It will nevertheless be understood that no limitation of the scope of the disclosure is intended by the illustrated examples.

### DETAILED DESCRIPTION OF EXAMPLE EMBODIMENTS

It is to be understood that this disclosure is not limited to the particular process steps or devices disclosed, but is extended to equivalents as would be recognized by those ordinarily skilled in the relevant arts. Alterations and further modifications of the illustrated features, and additional applications of the principles of the examples, which would occur to one skilled in the relevant art and having possession of this disclosure, are to be considered within the scope of the disclosure. It should also be understood that terminology employed herein is used for the purpose of describing particular embodiments only and is not intended to be limiting. The same reference numerals in different drawings represent the same element.

It should be noted that, as used in this specification and the appended claims, the singular forms “a,” “an,” and “the” include plural referents unless the context clearly dictates otherwise. Thus, for example, reference to a “crash risk factor” includes one or more of such crash risk factors, reference to a “driver behavior” includes reference to one or more of such driver behaviors.

Typical efforts attempting to connect individual driving behavior to insurance costs, particularly through pay-as-you-go insurance policies or distance-based insurance policies, have not been successful in collecting actual driver behavior for the driver being insured. Distance-based insurance policies have revolutionized the way automobile insurance is evaluated because the policies are more reflective of the individual mile-based risk and result in more fitting premiums. Similarly, behavior-based pay-as-you-go insurance policies provide context to those mile-based policies by providing information about the risks people take behind the wheel. Existing systems for behavior-based vehicle insurance rate determination are based upon penalties for risky behavior, primarily through a score penalty or an insurance cost penalty. But, these existing methodologies do not provide a method for quantifying driver behavior-related crash risk. The method disclosed can calculate crash risk, examine crash risk for different crash severities, consider the multiplicative effects of simultaneous risky behaviors, provide driver performance measurements in terms of mileage or duration, and calibrate the driver performance measurements in comparison to an average driver.

Many insurance companies currently use a combination of demographical information, mileage, driving record, and credit history, among others, to determine a driver's insurance rate premium. Each insurance company may use a different method in which some information is used in rate determination and some information is not used. Typically current methods are not openly transparent to the organization's policy holders. This lack of transparency can lead to insufficient information with which the policy holder can negotiate their premiums. Additionally, the types of information gathered during the rate determination process can provide an indirect assessment of a driver's risk where the statistical relationship shows a correlation between demographics and claim filing. These conflicting cases of information asymmetry can increase the cost for both the insurer and the insured. By supplying more precise information to the insurance company about the potential crash risk associated with an individual driver, the company can make a more accurate risk assessment for the insurance policy holder, which can improve the insurance company's ability to negotiate with customers over insurance rates. Moreover, by providing similar information to the customer, the driver's ability to negotiate with insurance companies improves because the customer can learn how their current and future driving behavior influences their risk exposure and how their risk exposure compares to the general population. Customers can have more control over their insurance rates by providing information about how their behavior affects their premium rates and creating a rate assessment system that can be sensitive to individual changes in behavior. Increasing available information to drivers and insurance companies by introducing a universal, transparent driving crash risk assessment system based on individual driving behavior and driving distance or duration for use in vehicle insurance rate determination can provide an insurance rate tailored to the individual's behavior. The method can improve overall driving safety and reduce crashes by incentivizing customers to eliminate or reduce unsafe driving behaviors.

The method presents steps for data collection and model estimation as components of a crash risk assessment system for actuarial use in safety-based insurance policies. For example, if a driving safety profile is determined for an individual consumer or user, insurance rates can be tailored to better capture the individual's collision risk. The method can reflect a driver's overall risk related to property damages and fatality losses induced by different crash types, and in many cases lower insurance premiums or act as an incentive for aggressive or inexperienced drivers to drive more safely.

The risk assessment method and model assembles information directly linking driver behavior to crash risk, where greater likelihood for collisions can indicate that the driver is more likely to file more insurance claims.

The “risk mileage” provides a measure of driver safety performance of the risk assessment system. The method can measure crash risk for multiple crash severities and can use various data collection systems which can be employed to record data inputs for the risk assessment method. A trip profile can be used to organize collected data and calculate the trip risk mileage. A calibration procedure can be used to define a baseline crash risk. A scoring model and cost calculation based upon risk mileage can use the risk mileage in insurance rate determination.

### Calculations Formulas Representing Driver Behavior-Related Crash Risk

The risk assessment system can utilize a multiplicative method to approximate the total crash risk and crash risk for different crash severities, over a period of time. The probability of being involved in a collision during one trip can be described by equation 1.

P(crash)_{α}=1−(1−P(crash))^{α} (1)

P(crash) can represent the probability of collision per unit exposure, a can represent the number of time/distance intervals (time or mileage), and P(crash)_{α} can represent the total probability of collision due to exposure. Equation 1 can apply to a single trip. Multiple trips can be approximated by performing a first-order linear expansion of the Maclaurin series. Other types of linear expansions can also be used, as can be appreciated.

f(p)=P(crash)_{α}=1−(1−P(crash))^{α} p=P(crash)a=0 (1.1)

Approximation:

$$f ( a ) + \frac{{f}^{′} ( a ) ( x - a )}{1 !} \qquad ( 1.2 )$$

f(a)=f(0)=1−(1−0)^{α}=0 (1.3)

f′(p)=0+α(1−p)^{α-1}=α(1−p)^{α-1} (1.4)

f′(a)=f′(0)=α(1−0)^{α-1}=α (1.5)

$$f ( a ) + \frac{{f}^{′} ( a ) ( x - a )}{1 !} = 0 + \frac{( a ) ( p - 0 )}{1 !} = pa \qquad ( 1.6 )$$

f(p)≅pα (17)

Equation 1.7 can approximate the probability of collision over a period of time if the probability of collision per unit exposure stays constant. Since the probability of collision per unit exposure can change due to behavior, equation 1.7 can be altered to accommodate variations in per unit exposure. A cumulative function can be used to calculate the collision probability for each unit measure of exposure and accumulate each unit measure of risk over the period of exposure to calculate the total probability of collision or collision types. Various methods can be used to calculate the probability of collision for each time interval. In a example, the method calculates a constant probability of collision, identified as P(Calibrated Crash), and accounts for the change in the probability of collision due to behavior by calculating the term identified as “Risk Mileage”. P(Calibrated Crash) can represent the probability of collision per unit exposure where no behavior considered in the method has occurred. “Risk Mileage” can represent the equivalent distance traveled to accumulate the same level of risk had no unsafe behavior considered in the method described taken place. Equation 2 illustrates a general risk mileage function.

$$Risk Mileage = {\sum }_{{Time}_{t = 1}} ( ( {\sum }_{{Behavior}_{t = 1}} ( \begin{matrix}Calibrated Risk {Ratio}_{i} \times \\ {Occurrence}_{i , t}\end{matrix} ) + Baseline ) \times {Mileage}_{t} ) \qquad ( 2 )$$

The terms described in equation 2 can be substituted into equation 1.7 which alters equation 1.7 to become equation 1.8.

P(Total Crash)=P(Calibrated Crash)(Risk Mileage) (1.8)

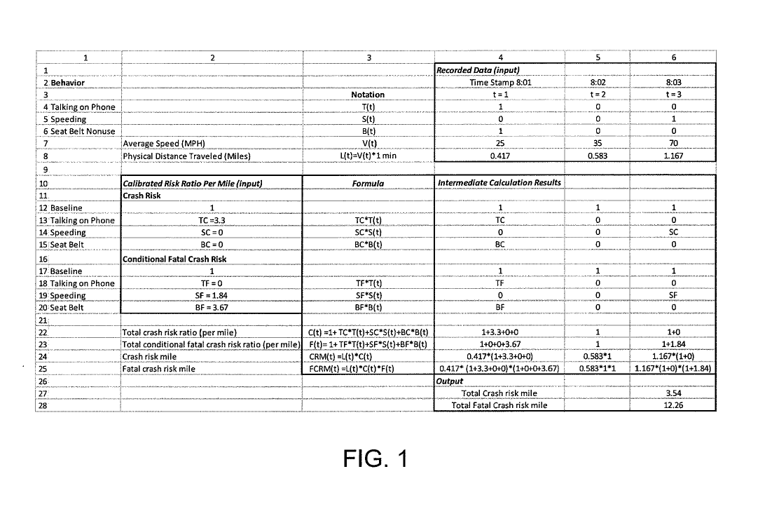

As shown in equation 2, “Calibrated Risk Ratioᵢ” can describe the Calibrated Risk Ratio for each behavior in the model and “Baseline” can represent the Baseline Risk Ratio, which are described below. The risk ratio can be applied as a multiplicative factor to consider the influence behavior has on risk. In equation 2, “Occurrence_{i, t}” can represent a variable for each behavior in the model indicating whether a behavior has taken place during each time interval. “Occurrence_{i, t}” can be represented in FIG. 1 as T(t) [FIG. 1, row 4, column 3], S(t) [row 5, col. 3], and B(t) [row 6, col. 3], where the occurrence data for each behavior can be stored in an array with a unique variable name and the index variable can be represented by the time interval. “Mileageₜ” can be the distance traveled over each time interval as L(t) [FIG. 1, row 8, col. 3], where the mileage for each interval can be stored in an array with the index variable represented by the time interval.

In situations where direct mileage data isn't available, an approximation can be made using average speed and the duration of the time interval, shown in equation 3.

Mileageₜ=Average Speedₜ×Time Interval (3)

As a result the Risk Mileage function can be described by equation 4.

$$Risk Mileage = {\sum }_{{Time}_{t = 1}} ( ( \begin{matrix}{\sum }_{{Behavior}_{t = 1}} ( \begin{matrix}Calibrated Risk {Ratio}_{i} \times \\ {Occurrence}_{i , t}\end{matrix} ) + \\ Baseline\end{matrix} ) \times \begin{matrix}Avg . {Speed}_{t} \times \\ Time Int .\end{matrix} ) \qquad ( 4 )$$

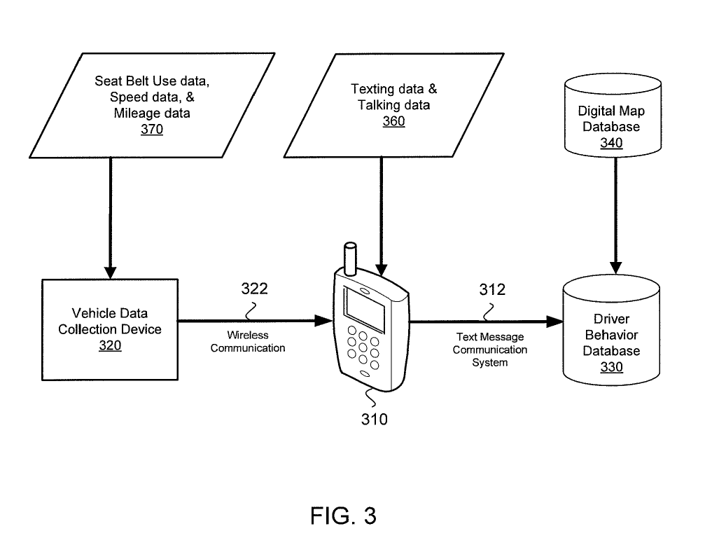

Equation 4 describes a basic function sensitive to travel time, distance, and speed. “Time Interval” can represent the sampling interval time duration, and “Average Speedₜ” can represent the average speed of the vehicle during each time interval and can be represented in FIG. 1 as V(t) [row 7, col. 3], where the average speed for each interval may be stored in an array with the index variable represented by the time interval. For each time interval (device sampling interval), the data collection system in FIG. 3 can record behavioral data and speed data in order to determine occurrence values and calculate an approximate distance traveled. Behavioral data can be collected using time stamps to record behavior violation duration while gathering speed or mileage data while the behavior takes place.

Equation 2 describes the Total Crash Risk Mileage function CRM(t), shown in equation 5, which can be further decomposed into a function consisting of a Total Crash Risk Ratio C(t), shown in equation 6, and the mileage over each time interval.

$$\begin{matrix}Total Crash Risk Mileage = C R M ( t ) = {\sum }_{{Time}_{t = 1}} ( \begin{matrix}Total Crash Risk {Ratio}_{t} \times \\ Avg . {Speed}_{t} \times Time Int .\end{matrix} ) & ( 5 ) \\ Total Crash Risk Mileage = C ( t ) = {\sum }_{{Behavior}_{t = 1}} ( \begin{matrix}Calibrated Crash Risk {Ratio}_{i} \times \\ {Occurrence}_{i} + Baseline\end{matrix} ) & ( 6 )\end{matrix}$$

“Occurrence_{i, t}” can be simplified to “Occurrenceᵢ” for the Total Crash Risk Ratio because the Total Crash Risk Ratio is calculated for each time interval and thus the Occurrence variable refers to one time interval when used in a calculation. Substituting the variables in equations 5 and 6 with equivalent terms (TC [row 13, col. 2], T(t) [row 4, col. 3], SC [row 14, col. 2], S(t) [row 5, col. 3], BC [row 15, col. 2], B(t) [row 6, col. 3], L(t) [row 8, col. 3], and V(t) [row 7, col. 3]) used in FIG. 1, equation 5 returns equation 8 and equation 6 returns equation 7, which is provided as C(t) [row 22, col. 3] and CRM(t) [row 24, col. 3] in FIG. 1.

C(t)=TC×T(t)+SC×S(t)+BC×B(t)+1 (7)

CRM(t)×C(t)×L(t)=C(t)×V(t)×t (8)

Equations 7 and 8 can calculate the risk mileage for each time interval. The method can include many behaviors occurring during one time or distance interval (illustrated in FIG. 1, rows 4-6, cols. 1 and 4-6), which can compound the overall crash risk and increasing the crash risk ratio compared to a simple linear additive method. Thus, a composite value may be calculated which includes all of the crash risk factors which occur in a particular interval (or otherwise assigns a value which does not change the crash risk, e.g. 1). The characteristic of using a combined crash risk factor can provide a more representative risk assessment of the combined behaviors than adding individual risk factors together.

### Examples of the Method Using Risk Mileage

Crash risk can be decomposed into representative components (including fatal crash risk and injury crash risk) using risk mileage as a measure of crash risk. Examples can use derivative forms of the risk mileage equations previously disclosed.

FIG. 1 identifies the Total Conditional Fatal Crash Risk Ratio [row 23, cols. 2-3] and Fatal Crash Risk Mileage [row 22, cols. 2-3] functions in the Formulas column [rows 10-25, col. 3]. The Total Conditional Fatal Crash Risk Ratio can be described as the total additional relative risk due to behaviors that affect fatal collision probability in addition to the Baseline Fatal Risk Ratio. The probability of being involved in a fatal collision depends on a crash already taken place, thus a case of conditional probability. For example, equation 9 can be used calculate the probability of being involved in a fatal collision.

P(fatal crash)=P(crash)×P(fatal crash) (9)

The value P(fatality|crash) can be the probability of a crash resulting in a fatality, whereas P(fatal crash) can be the probability of being involved in a fatal collision. The relationship between P(crash) and P(fatal crash) indicates that the change in P(crash) due to behavior would also influence P(fatal crash) by the relationship applied in equation 2. The influence of behavior causing a fatal crash can be shown in equation 10.

F(fatal crash)=(Total Crash Risk Ratio×P(crash))×(Total Conditional Fatal Crash Risk Ratio×P(fatality|crash) (10)

Applying equation 10 in reference to equation 2 can result in equation 11 and equation 12.

$$Fatal Crash Risk Mileage = F C R M ( t ) = {\sum }_{{Time}_{t = 1}} ( \begin{matrix}Cond . Fatal Crash Risk {Ratio}_{t} \times \\ Average {Speed}_{t} \times Time Interval\end{matrix} ) \qquad ( 11 )$$

### Calibrated Crash Risk Ratioᵢ

[Please Confirm Equation 12?]

A similar relationship can occur for Injury Crash Risk Mileage and the Conditional Injury Crash Risk Ratio using the same principle. Injury Crash Risk Mileage and the Conditional Injury Crash Risk Ratio are not shown in FIG. 1 to maintain visual simplicity. Substituting the variables in equations 11 and 12 with equivalent terms (TF [row 18, col. 2], T(t) [row 4, col. 3], SF [row 19, col. 2], S(t) [row 5, col. 3], BF [row 20, col. 2], B(t) [row 6, col. 3], C(t) [row 22, col. 3], L(t) [row 8, col. 3], and V(t) [row 7, col. 3]) used in FIG. 1, equation 11 returns equation 14 and equation 12 returns equation 13, which is provided as F(t) [row 23, col. 3] and FCRM(t) [row 25, col. 3] in FIG. 1.

F(t)=(TF×T(t)+SF×S(t)+BF×B(t)+1) (13)

FCRM(t)=F(t)×C(t)×L(t)=F(t)×C(t)×V(t)×t (14)

### Method Inputs

The Calibrated Risk Ratio [FIG. 1, row 10, col. 2] can be a derivative of the relative risk ratio, which can describes the additional risk exposure due to a driver's behavior. Relative risk ratios can be reported as odds ratios in highway safety literature, and the odds ratio can roughly approximate the relative risk associated with those behaviors because the event (collision) for which the odds ratio was calculated can be considered a rare event. The relative risk can be composed of the risk without exposure and the additional risk due to exposure, where exposure can be defined as the driver undertaking the behavior associated with the risk factor in question. The risk without exposure can describe the risk present when the driver does not undertake the behavior in question, which can account for externalities and other factors present when the event occurred that may not be accounted for when calculating the relative risk (confounding factors). The risk associated with non-exposure, which can be represented as the “Baseline” Risk Ratio [rows 12 and 17, cols. 1-2], can be combined into a single constant during calculations, as shown in FIG. 1. Thus, the Calibrated Risk Ratio, which can be represented as the additional relative risk ratio, can be equal to one-less-than the relative risk ratio (calibrated risk ratio=additional relative risk−1).

The Calibrated Risk Ratios for each behavior considered in the model can be classified by collision probability and collision severity because the level of influence that different behaviors have on different types of collisions can be considered in the analysis. For instance, driving without wearing a seat belt doesn't increase the likelihood of being involved in a collision, but it does increase the likelihood of serious injury resulting from the collision. The ratios affecting collision probability can be called Calibrated Crash Risk Ratios [row 22, cols. 2-3] and are represented by TC [row 13, col. 2], SC [row 14, col. 2], and BC [row 15, col. 2] in FIG. 1. The ratios affecting collision severity, which can be separated into fatal collisions and injury collisions, can be called Calibrated Fatal Crash Risk Ratios [row 23, cols. 2-3] and Calibrated Injury Crash Risk Ratios (not shown in FIG. 1), which are represented by TF [row 18, col. 2], SF [row 19, col. 2], and BF [row 20, col. 2] in FIG. 1.

In another example, Calibrated Risk Ratios used in the model can be a product of analyzing values reported in research literature related to driving safety. The risk ratios should not be interpreted as permanent constants, but rather flexible constants that can respond to new research findings. The risk ratio values can be calibrated for different population groups or market segments (e.g., teen drivers, commercial fleet drivers, aged drivers) and used in the analysis separately. The values used in the analysis can be adjusted based on values from other studies when the studies become available, or the values can be produced from the data collected using the system disclosed. The risk ratios can be tailored to specific considerations of an insurance company based on company preference or analysis from the insurance company's user data.

### Relating Behavior and Crash Risk

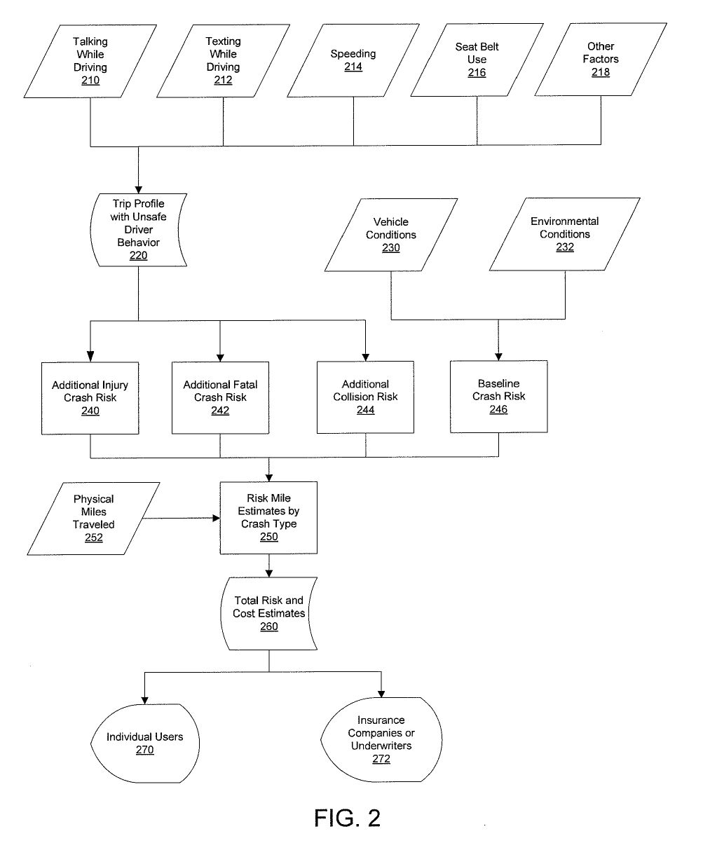

FIG. 2 is a flow chart depicting driver behavior as a factor in vehicle collision and collision severity (in relation to other pertinent factors), data handling after collection, calculations, and analysis with system inputs and outputs in accordance with an example. FIG. 2 identifies the relationships between the factors represented by the formulas identified in FIG. 1 and the exemplary risk mileage calculations therein, and identifies the outputs identified in the flow chart. Multiple outputs 270 and 272 can be employed so that the assessment method may provide different risk analyses for drivers, consumers, insurance companies, and underwriters.

Talking while driving 210, texting while driving 212, speeding 214, seat belt use 216, and other factors 218 are examples of driver behaviors that affect the risk of collision and collision severity. The data can be recorded by a system and organized in a trip profile 220 (such as the example profile described in FIG. 1). The trip profile can identify the additional collision risk 244 of being involved in a collision through the Calibrated Crash Risk Ratio [FIG. 1, row 22, cols. 2-3], and the additional fatal crash risk 242 and additional injury crash risk 240 of the collision resulting in fatality or injury through the Calibrated Fatal Crash Risk Ratio [FIG. 1, row 23, cols. 2-3] and Calibrated Injury Crash Risk Ratio (not shown in FIG. 1). The Baseline Crash Risk 246 can use the Baseline Crash Risk Ratio [FIG. 1, rows 12 and 17, col. 2] and can be a result of environmental conditions (factors) 232 (e.g., weather, roadway alignment), vehicle conditions (factors) 230 (e.g., size, weight, safety features), and behavioral factors (not shown in FIG. 2) that may not be currently monitored as unsafe driving behaviors. The Baseline Crash Risk Ratio can be further divided into components which include the Baseline Fatal Crash Risk Ratio and Baseline Injury Crash Risk Ratio that act as counterparts to the Calibrated Fatal Crash Risk Ratio and Calibrated Injury Crash Risk Ratio to describe the Total Conditional Fatal Crash Risk Ratio and Total Conditional Injury Crash Risk Ratio in addition to the Total Crash Risk Ratio.

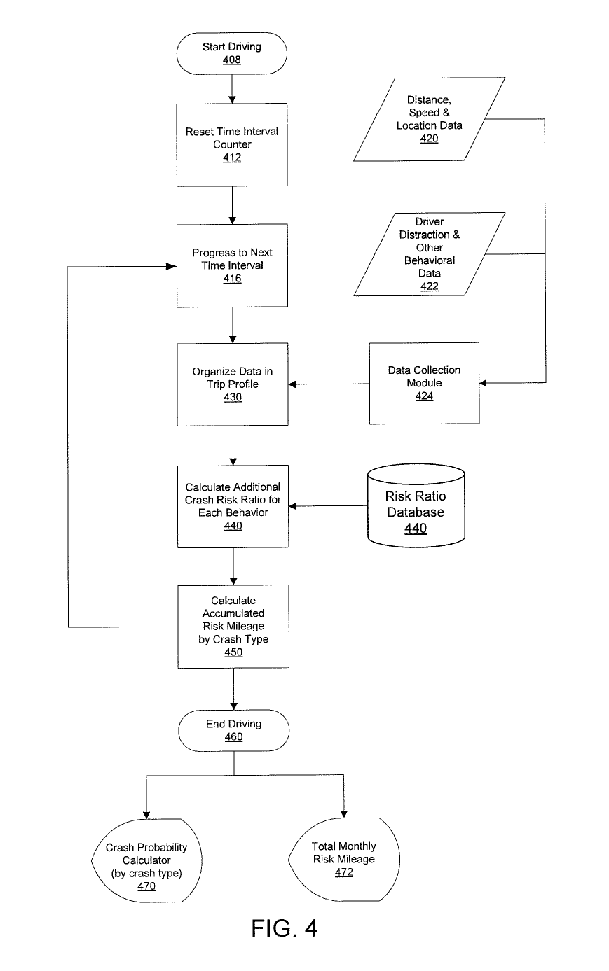

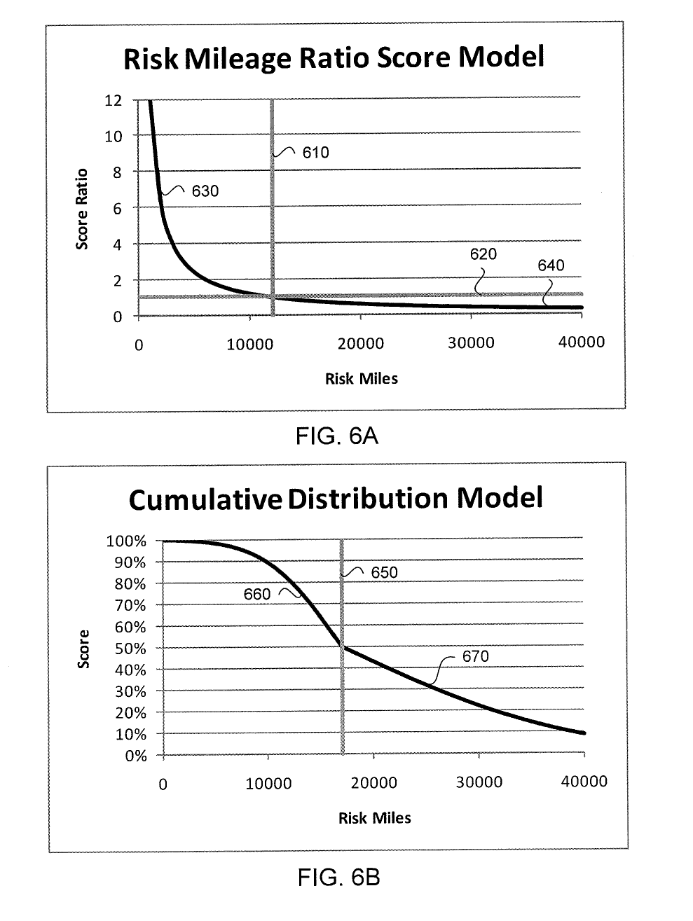

The risk ratios 240, 242, 244, and 246 can be inputs for the risk mileage by crash type 250 function shown as Risk Mileage [FIG. 1, rows 24-25, cols. 2-3] and shown in a visual representation in FIG. 4. The risk mileage by crash type function (and/or crash severity) combines the risk ratios and physical miles traveled 252 to produce risk mileage estimates based on all crashes as well as fatal crashes and injury crashes. Once the risk mileage estimates are calculated for different collision types, the result can be combined to produce the Total Risk Mileage [FIG. 1, rows 27-28, cols. 4-6] by applying multiplicative factors to each risk mileage type. These multiplicative factors represent the value of each risk mileage estimate in relation to the goals of the analysis described in FIG. 6A and FIG. 6B (described in more detail in a later section). The risk mileage estimates can be used to for the total risk and cost estimates 260 associated with the unsafe behaviors that the risk mileage estimates consider. The total risk and cost estimates can be used to provide a risk analysis for individual users 270, drivers, consumers, or insurance companies or underwriters 272.

### Data Collection System

FIG. 3 provides a flow chart depicting a data collection architecture employed to communicate speed, mileage, phone use, and other data through a cell phone or similar device. The system comprises a vehicle data collection device 320, such as an on-board sensing device or GPS location data collection device to gather driver behavior information, a cell phone 310 or mobile computing device, a mobile computing usage monitoring application to gather information about phone use, which can be optionally configured to block non-emergency phone use while driving. The vehicle data collection device can be used to collect data from the vehicle which can include seat belt use data, speed data, mileage (traveled) data 370, and vehicle ignition data. The on-board data collection device can communicate with the application on a driver's cell phone via a wireless communication 322 or connection, such as a connection using Bluetooth compliant wireless transceivers. The phone application can block or monitor incoming and outgoing calls and text messages (texting data and talking data 360) while the vehicle is operating, and can collect phone use data when authorized (i.e., emergency) communication is initiated through a cell phone installed application.

The collected data can be transmitted by text messages via a text message communication system 312 to driver behavior database 330 on a server away from the vehicle for processing and storage. Alternatively, the data can be sent to the server by other message formats or communication channels. Data processing can incorporate several analysis methods to identify risky behaviors. For example, the collected speed data for a trip may be merged with information from a digital map database 340 to define speed violations. Once data processing is complete, the data can be organized into a trip profile as illustrated in FIG. 1 although other formats can be used.

Alternatively, data processing can be performed on the driver's cell phone or similar device to identify risky behaviors. A client application on the cell phone can send the driving safety violation data to the server in real time and/or at the end of a trip to provide desired notification and storage. In another example, the server can obtain the information about the actual mileage from a client on a periodic basis, such as a weekly or a monthly basis. With additional violation data within the last week or month, the server can calculate the risk mileage and driving safety score using the method described in FIG. 4. The risk mileage can be calculated on the server side or by the cell phone application.

### Trip Profile

Referring back to the trip profile illustration of FIG. 1, the first column identifies the behaviors considered in accordance with an example. This exemplary list of behaviors is not intended to show limitation of the method described. The second column labeled Calibrated Risk Ratio Per Mile identifies the variable name for each risk ratio associated with each driving behavior identified in the first column and an exemplary value applied in the Intermediate Calculation Results shown in the fourth column. The portion of the third column labeled Notation identifies the structures and variable names used to organize the Recorded Data. The Recorded Data can be collected by the system described in FIG. 3 for use in the equations identified in the column labeled

Formulas and applied in the Intermediate Calculation Results beginning in the fourth column. The portion of the third column labeled Formula identifies the equations used to calculate risk mileage, which are applied in the Intermediate Calculation Results shown in the fourth column. The 26th through 28th rows labeled Output shows accumulated risk mileage by crash type from the results of the Intermediate Calculation Results for use in further analysis described in FIG. 2.

### Intermediate Calculation Results for Example Data in FIG. 1 for Trip Profile

The following example describes how data may be organized in a trip profile after being recorded by the system described in FIG. 3 and provides a situational application of a trip profile to explain the intermediate calculation results shown in FIG. 1.

Data recorded for a trip can be organized in the section labeled Recorded Data [rows 1-8, cols. 4-6] in FIG. 1, where the trip can be divided into time intervals from column four to column six (left to right) across each column. For each time interval, the data collection device records average speed data or distance data (when available) while monitoring for behavioral violations, such as speeding, talking on the phone while driving or texting on the phone while driving. Time stamps can be used for determining behavior durations rather than time intervals for more accurate assessment, where the time stamps can be assigned to time intervals or the time intervals can be specified in reference to the time stamps when behavioral violations take place.

At time interval 8:01 [col. 4] in the example of FIG. 1, the driver takes off their seat belt so they can reach into the backseat to pick up their cell phone and answer a short incoming call while traveling about 25 MPH. As a result, two unsafe behaviors, namely talking on the phone while driving [row 4, col. 4] and seat belt non-use [row 4, col. 6], occur simultaneously or within the same interval. The physical distance traveled in that time interval is 0.417 miles [row 8, col. 4]. The total crash risk mileage for this interval is (1+3.3+0+0)*0.417=1.792 miles [row 24, col. 4] and the fatal crash risk mileage for this interval is (1+3.3+0+0)*(1+0+0+3.67)*0.417=8.367 miles [row 25, col. 4].

At time interval 8:02 [col. 5], the driver has finished talking on their cell phone and remembered to buckle up while increasing their speed to about 35 MPH. As a result, no unsafe behaviors considered by the model have taken place and the physical distance traveled in that time interval is 0.583 miles [row 8, col. 5], The total crash risk mileage for this interval is (1+0+0+0)*0.583=0.58 miles [row 24, col. 5] and the fatal crash risk mileage for this interval is (1+0+0+0)*(1+0+0+0)*0.58=0.58 miles [row 25, col. 5].

At time interval 8:03 [col. 6], the vehicle has turned onto an arterial street with a 55 MPH speed limit while traveling about 70 MPH. As a result, one unsafe behavior, speeding [row 5, col. 6], has taken place over the time interval. The physical distance traveled in that time interval is 1.17 miles [row 8, col. 6]. The total crash risk mileage for this interval is (1+0+0+0)*1.167=1.167 miles [row 24, col. 6] and the fatal crash risk mileage for this interval is (1+0+0+0)*(1+0+1.84+0)*1.167=3.313 miles [row 25, col. 6].

The Outputs [rows 26-28, cols. 4-6] in FIG. 1 shows the crash risk mileage [row 27, cols. 4-6] and fatal crash risk mileage [row 28, cols. 4-6] accumulated over the duration of the trip. In reference to the example provided above, the cumulative crash risk mileage for the trip is (1.792+0.583+1.167)=3.54 miles [row 27, col. 6] and the cumulative fatal crash risk mileage for the trip is (8.367+0.583+3.313)=12.26 miles [row 28, col. 6]. The risk mileage can be calculated for each crash type and then aggregated to a total risk mileage to be used for analysis, as described earlier in FIG. 2.

### Example of Implementation

FIG. 4 illustrates a flow chart depicting the risk mileage calculation for one trip with outputs 470 and 472 that can be used in risk mile estimates by crash type 250 (FIG. 2). The distance, speed & location data 420, driver distraction & other behavioral data 422 can be data collected by the devices described in FIG. 3, which is represented as the Data Collection Module 424. The data inputs can be stored and organized in the Trip Profile, which is illustrated by FIG. 1. The majority of the remaining components in the flow chart identify the steps performed to calculate risk mileage as represented by equation 2.

The risk mileage can be accumulated over the duration of the trip, whereupon the risk mileage for the trip may be combined with the risk mileage from previous trips to calculate the risk mileage over an extended period of time (e.g., one month or one year). The risk mileage can be used to calculate the probability of collision applied in the cost estimation methods described in FIG. 2.

In FIG. 4, when the user starts driving 408, the system timer or counter identifying the time intervals for the trip is reset 412. As the first time interval passes 416, the data collected from the on-board data collection device and cell phone can be sent to the server (or stored on the cell phone) and can be organized in the Trip Profile 430. The server or the mobile device can function as the module which performs the crash risk analysis. The inner summation function in equation 2 can be represented by Calculating Additional Crash Risk Ratio for Each Behavior 440. The data in the Trip Profile can be combined with the Calibrated Risk Ratios from the Risk Ratio Database 440 to calculate the Crash Risk Ratio, as described by equation 7, and the Conditional Crash Risk Ratios for each behavior as described by equation 14 and a similar calculation for injury crashes. The outer summation function in equation can be represented by Calculate Accumulated Risk Mileage by Crash Type 450. The system calculates the risk mileage for all crashes and fatal and injury crashes separately for the time interval and adds the term to the cumulative risk mileage term identified in FIG. 1 as Total Crash Risk Mileage [row 27, cols. 4-6], Total Fatal Crash Risk Mileage [row 28, cols. 4-6], and Total Injury Crash Risk Mileage (not shown in FIG. 1). The method can progress to the next time interval 416 and repeat the calculating the Crash Risk Ratio and the Conditional Crash Risk Ratios for each interval and the Total Crash Risk Mileage, the Total Fatal Crash Risk Mileage, and the Total Injury Crash Risk Mileage at the end of each interval.

Once driving ends 460 (the trip ends), the cumulative risk mileage calculated for the trip may be added to the risk mileage from previous trips to calculate the risk mileage over a pertinent period of time (e.g., a month or a year). Collected risk mileage can be stored according to individual trips and/or as a cumulative value. In either case, the cumulative risk mileage can be used to calculate the probability of collision for application in the cost estimation methods described in FIG. 2 or the analysis methods described in FIGS. 6A and 6B to be reported to either individual users, insurance companies, or underwriters. Individual risk mileage can optionally be adjusted or eliminated based on information which provides mitigating facts to change the risk assessment (e.g. phone was not in possession of the owner during that trip, etc).

The information provided to insurance companies and drivers can be provided through an open, transparent system in which driving behavior and risk assessment data can be shared openly with drivers and insurance companies. The driver may be able to access a collection of the data representing their mileage and behavior over a significant past time period from which to glean information regarding their risk exposure, a record of their risk mileage, or a driving score derived from their risk mileage to show how their behavior influences their insurance premiums. This information can be supplied via a display and/or printed report. For example, the driving score and/or high risk behaviors can be reported via a website portal to the server, delivered directly to the driver cell phone, delivered to a secondary cell phone (i.e. parent or supervisor), emailed to an interested party, other electronic communication, or printed. The risk mileage or driving score can then be shared with the driver's insurance provider to help determine the driver's insurance premium or the score can be shared with multiple companies to compare premiums. This universal risk assessment system allows drivers to move their data between their chosen insurance company during a transition between policies. Additionally, companies can choose how they want to integrate the risk mileage data into their actuarial analysis system and even tailor components of the risk mileage calculations as part of the transparent framework. The data collected from drivers can be used to further improve the risk ratios, multipliers, or other components of the risk assessment system disclosed. For example, the driving score can be classified into an actuarial category which is then used to determine and/or apply an adjustment to an insurance premium rate for the driver. Ultimately, the driving score will often be a component in the assignment of the actuarial category. Other non-limiting examples of other components which may be considered include age, health, geographic locations, occupation, etc.

### Calibration Process

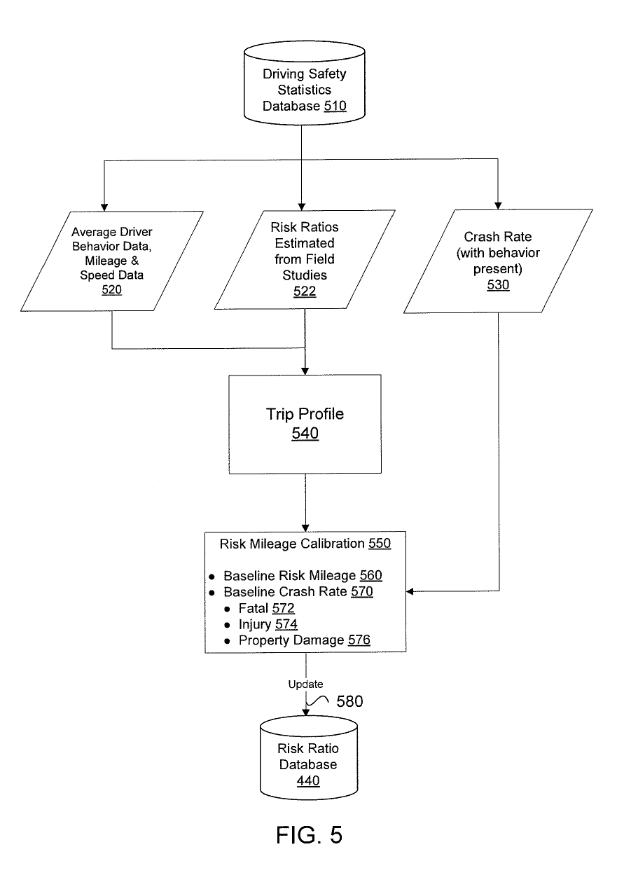

FIG. 5 illustrates a flow chart depicting the baseline calibration process for each crash type. The calibration process can calculate the term P(Calibrated Crash) introduced in equation 1.8. The calibration process can calculate the probability of a collision when no unsafe behavior considered in the model has taken place. Referred as the baseline crash rate 570, P(Calibrated Crash) can be categorized by crash type for fatal crashes 572, injury crashes 574, and property-damage-only (PDO) crashes 576 and applied to the cost estimation methods described in FIG. 2 and further described in FIG. 5.

To assist in the calculation of the probability of collision for each time interval, the method can calculate a constant probability of collision, referred to as P(Calibrated Crash). The method can account for the change in the probability of collision due to behavior by calculating the Risk Mileage [row 24, col. 3] described in FIG. 1. As described before, equation 1.7 can be represented by equation 1.8, where P(Calibrated Crash) can represent the probability of collision per unit exposure where no behavior monitored in the method has occurred and P(Stat. Crash) can represent the Crash Rate 530, as shown in FIG. 5.

Since P(Calibrated Crash) can be constant for cost estimate calculations, the value calculated for P(Calibrated Crash), and by connection P(Stat. Crash),can represent the average probability of collision that applies to the general population. An approximation to an average probability of collision can be a product of national crash statistics and highway statistics. National Highway Traffic Safety Administration (NHTSA) crash statistics can be used to approximate the number of crashes occurring annually in the United States, and Federal Highway Administration (FHWA) statistics can be used to approximate total risk exposure to the population. NHTSA crash statistics and FHWA statistics can consist of the total number of police-reported crashes by type (including the number of fatalities and injuries) collected by the NHTSA each year and the annual estimate of vehicle miles traveled produced by the Federal Highway Administration. The method can be demonstrated with equation 15.

$$P ( Stat . Crash ) = \frac{\# of Crashes}{Vehicle Miles Driven} \qquad ( 15 )$$

Many crashes go unreported each year, so another example can consider unreported crashes during calibration. Just as risk ratios reported in FIG. 1 may change with continuing research, crash statistics can change from year to year depending on several factors. By allowing for this flexibility, the outputs of the system disclosed can change as population characteristics change.

Since the members of the population from which these estimates are made perform some of the unsafe behaviors accounted for in the method described, and P(Calibrated Crash) can represent the probability of collision per unit exposure where no behavior monitored has occurred, the effect on the probability of collision due to the behaviors of the population can be accounted for to determine P(Calibrated Crash). To account for the effect average driver behavior has on the average probability of collision, the risk mileage for an average driver can be estimated. Equation 16 can be a modified form of equation 1.8 that describes this relationship. Equation 16 can be further simplified to equation 17 where the “Total Crash Risk Ratio for Avg. Driver” can be represented as the Total Crash Risk Ratio [row 22, cols. 2-3] described in FIG. 1 for an average driver.

P(Stat. Crash)(Average Actual Mileage)=P(Calibrated Crash)(Average Driver Risk Mileage) (16)

P(Stat. Crash)=P(Calibrated Crash)(Total Crash Risk Ratio for Avg. Driver) (17)

Using the simplification in equations 16 and 17, the Total Crash Risk Ratio can be calculated rather than the risk mileage because P(Calibrated Crash) can be independent of the distance traveled, but the risk mileage may still be calculated for use in the analysis outputs shown in FIG. 6A and FIG. 6B. P(Calibrated Crash) can be further divided into P(Calibrated Fatal Crash), P(Calibrated Injury Crash), and P(Calibrated PDO Crash) maintaining the conditional properties of the probability of collision by type described in equation 17. In calculating the Calibrated Crash Risk Ratios for each crash type/severity, behavioral data for an average trip for an average driver can be translated into occurrence values and applied to equation 7 for a Calibrated Crash Risk Ratio, equation 13 for a Calibrated Conditional Fatal Crash Risk Ratio, and derivatives of equation 13 for the Calibrated Conditional Injury Crash Risk Ratio and Calibrated Conditional PDO Crash Risk Ratio.

To replicate an average trip, information about average travel times, distances traveled, and behavioral prevalence can be estimated or taken from statistical data. Travel times and distances can be accumulated from the National Household Travel Survey, the Federal Highway Administration, American Community Survey, the U.S. Census Bureau, the Omnibus Survey Results through the Bureau of Transportation Statistics, and other sources. From these publications, an exemplary average trip can take 24 minutes to travel 15 miles one way. For the 24 minute trip (assumed to be traveling at a constant speed for simplification purposes), a driver speeding about 15% of the time spends about 4 minutes speeding, makes a 3 minute phone call, and takes off their seatbelt for 1 minute (about 5% of the trip).

Driver behavior characteristics can be collected from several resources. An estimate of the 2.3 minutes for the average phone call duration while driving has been used quite commonly when estimating the societal cost of talking while driving, but 2.3 minutes value was rounded up to 3 minutes for a conservative estimate in the 24 minute trip example. Speeding was estimated to take place for about 15% of each trip based on data collected from Driving Alexandrians Safely Home (DASH). Seat belt status data from the National Occupant Protection Use Survey (NOPUS) indicates that 83% of people were wearing their seatbelts during the survey, but the survey doesn't provide an estimate of how often an average driver wears their seat belt. Since seat belt use in many states surpasses 90%, an inferred decision was made identifying average drivers using their seat belt 95% of the time. These calibration inputs can be used as an example to illustrate the calibration process below.

Using the average driver and trip data described above, which can be stored in the Driving Safety Statistics Database 510 shown in FIG. 5, the data can be collected in a Trip Profile 540 to calculate the Calibrated Crash Risk Ratios [row 22-23, cols. 2-3] as described in FIG. 1. The Trip Profile can be generated from Average Driver Behavior Data, Mileage & Speed Data 520 from surveys and statistics or Risk Ratios Estimated from Field Studies 522. The Trip Profile can be used to generate a Risk Mileage Calibration 550 and a Baseline Risk Mileage. Once the Total Calibrated Crash Risk Ratio, Total Conditional Fatal Crash Risk Ratio 572, and Total Conditional Injury Crash Risk Ratio 574 are calculated, simple algebra returns the Baseline Crash Rate 570 described in equation 17.1 and the derivative forms separated by crash type, such as a Baseline Fatal Crash Rate represented by equation 17.2.

$$\begin{matrix}P ( Calibrated Crash ) = \frac{P ( Stat . Crash )}{( Total Crash Risk Ratio for Avg . Driver )} & ( 17.1 ) \\ P ( Calibrated Fatal Crash ) = \frac{P ( Stat . Fatal Crash )}{( Total Cond . Fatal Crash Risk Ratio for Avg . Driver )} & ( 17.2 )\end{matrix}$$

The Risk Mileage Calibration 550 can update 580 a Risk Ratio Database 440 that can be used in the method described in FIG. 4. Once these calculations are made, the crash probabilities for a driver with known behavior, speed profile, and travel time can be calculated using the method described in FIG. 2.

### Risk Mileage-Based Scoring Models

FIG. 6A and FIG. 6B are exemplary illustrations of scoring models used to communicate relative risk levels to drivers and insurance companies or underwriters. A method used to communicate performance can be to provide a score as feedback. The scoring method shown in FIG. 6A applies a ratio comparing the calculated Crash Risk Mileage to the risk mileage of an average driver who had undertaken no unsafe behavior considered in the method disclosed over the period of one year. For illustration, the average Crash Risk Mileage 610 who had undertaken no unsafe behavior for a year is 12,000 miles with a score of one 620. The ratio can be calculated with equation 18 where the comparison terms in the formula may be changed as desired to generate a score.

$$Safe Driving Score = \frac{Crash Risk Mileage}{12000 Miles} \qquad ( 18 )$$

For example, the ratio can be applied on a monthly basis as opposed to yearly basis. The term Crash Risk Mileage may be replaced with Total Crash Risk Mileage, or the denominator or “Comparison Term” can be replaced with the average driver risk mileage calculated in the calibration process described in FIG. 5. Since insurance companies already calculate rates by risk classification, a relative risk comparison to the average driver allows an underwriter to incorporate this scoring method into their risk classification methods used for rate determination. In the example of FIG. 6A, a driver with a lower Crash Risk Mileage 630 than the average can receive a score greater than one, and a driver with a higher Crash Risk Mileage 640 than the average can receive a score less than one.

The scoring method shown in FIG. 6B applies a probabilistic distribution whereupon the score is determined by the calculated risk mileage, or a derivative thereof, in reference to the average driver risk mileage 650 described before. A normal distribution can be described by the average, standard deviation, and skew, which can be adjusted for the desired results to produce a scoring model on a scale between 0% and 100%. Under such a system, the score can take a probabilistic distribution based on the calculated risk mileage, and the distribution can be adjusted to the average driver risk mileage calculated in the calibration process described in FIG. 5 in addition to altering the standard deviation and skew to spread the distribution for desired classification. Scoring based on this kind of scale can prove useful to drivers and consumers because the scoring system can be more familiar to them, and thus much easier to interpret. For example, a driver with a risk mileage 660 less than the average can have a score greater than 50% and a driver with a risk mileage 670 greater than the average can have a score less than 50%.

In another example, the score can be determined by other derivatives of risk mileage, rather than the risk mileage data alone. For example, for new drivers or teen drivers who use long driving distances to practice, the score can be determined by the average risk ratio when practice mileage is satisfied. The average risk ratio can be represented as the actual risk mileage divided by the risk mileage with no unsafe behavior present. For short-distance commuters who log short driving mileage and to encourage safe driving habits, a higher weight can be assigned to the average risk ratio than the actual risk mileage. In another example, the score can be determined by expected insurance costs or expected insurance cost savings. Expected insurance cost savings can be calculated as the difference between expected insurance costs and average insurance costs with unsafe driving behavior present.

The score can be provided to the driver through electronic media with information about the behavior undertaken to explain their score and encourage the user to improve their driving habits. Transparency in scoring methodology for both the policy holder and the policy provider allows more information to be shared between each participating member of the vehicle insurance contract. By sharing more information about their self, the policy holder and the policy provider can acquire more information about the other party, allowing them both to modify their behavior and rate classification to optimize their benefits from the issued policy and increase market competition among drivers and insurance companies.

### Calculating Economic Cost

In another example, a method is disclosed for estimating the cost per collision for each type of collision and combines the estimates with baseline crash rates described in FIG. 5 and risk mileage estimates for each collision type. The method can be used to return the total cost per trip or per mile for further analysis or for insurance rate determination. The economic cost associated with different crash types can often be used to determine the cost to society due to a collision taking place. However, the cost to an insurance company may not include all factors considered in these cost estimates. The method disclosed can employ several different sources and/or methodologies to estimate the cost per collision, including a standardized methodology developed by the NHTSA which may consider property damage, medical expenses, insurance administration, travel delay, legal costs, lost productivity, and several other factors defining the cost of a collision. When evaluating the cost to insurance companies, some of these factors might not apply, so custom estimates can be developed based on the desired factors for use in internal calculations.

The method can calculate the cost per victim rather than cost per collision. Using national crash statistics from the Driving Safety Statistics Database described in FIG. 5, cost estimates can be increased by the ratio of crash victims to vehicle crashes for fatal and injury crashes as represented by equation 19.

$$Cost per Fatal Crash = ( \frac{Fatal Crash Victims}{Fatal Vehicle Crashes} ) ( Cost per Fatality Victim ) \qquad ( 19 )$$

To calculate the cost over a period of time, the relationship can be described by equation 20 where P(Calibrated Crash)(Risk Mileage) is equivalent to equation 1.8.

Cost=(Cost per Crash)(P(Calibrated Crash)(Crash Risk Mileage) (20)

P(Calibrated Crash) can be applied as a constant in equation 1.8 while the risk mileage changes in response to driver behavior. P(Calibrated Crash) can represent a product of the calibration method described in FIG. 5 having units of crash per distance traveled. Equation 20 can be used for fatal crashes and injury crashes, but no risk mileage value is calculated for property-damage-only crashes, so a similar method can be employed to yield property-damage-only crash cost estimates. Considering the conditional probability for crash types, the P(Calibrated Fatal Crash) can be described by equation 21.

P(Calibrated Fatal Crash)+P(Calibrated Injury Crash)+P(Calibrated PDO Crash)=P(Calibrated Crash) (21)

P(Calibrated Fatal Crash) and P(Calibrated Injury Crash) can be calculated in the calibration process described in FIG. 5. P(Calibrated PDO Crash) can be determined so and applied in a modified form of Equation 20 to estimate the cost associated with PDO crashes provided by equation 22).

Cost_{PDO}=(Cost per PDO Crash)(P(Calibrated PDO Crash))(Actual Mileage) (22)

Once costs are calculated, a cumulative cost for the driver's behavior can be calculated by summing the costs for each crash type.

Several outputs can be reported from the method, including risk mileage by itself, the ratio of total crash risk mileage to actual mileage driven, and the cost associated with behavior. The outputs can either be used for their inherent value or analyzed in relation to an average driver for relative comparisons. Comparisons can be made using probability distributions or simple ratios for greater analytical purposes, which are discussed in FIG. 6A and FIG. 6B. Since each output described communicates different information, and the value associated with the information communicated is different depending on the receiving party, different outputs can be made available to drivers and insurance companies/underwriters.

Non-limiting examples of suitable systems and methods can include many different configurations and arrangements. For example, a computer-implemented method to calculate risk mileage based on input data for a single trip and multiple trips (online or offline), and input data may be defined to include multiple behaviors taking place at the same or different time intervals. Another example includes an architecture for collecting data from multiple data sources to assess a driver's risk associated with behavior (including cell phone and other mobile computing device-related driving distraction) and mileage. A computer-implemented method can be provided to calculate risk mileage or other derivative for a driver and an insurance underwriter (online or offline). In yet another example, a computer-implemented method can be used to calculate an accumulated risk from real-time sensor and mobile phone usage data in a vehicle. A computer-implemented method can be used to differentiate risk associated with different crash types and different base-line risk profiles. Further, a computer-implemented method can be used to integrate mileage and driver behavior into risk assessment and provide data consistent with distance-based assessment when behavior data is not available. Also, a computer-implemented method can be used to calibrate the baseline risk associated with representative driving behavior for crashes resulting in fatality, injury, and property damage, while the baseline risk profile can be calibrated and adjusted for different groups of population. In yet another optional aspect, a computer-implemented method can be used to compare and rank a driver's risk relative to population and present results to insurance companies and users.

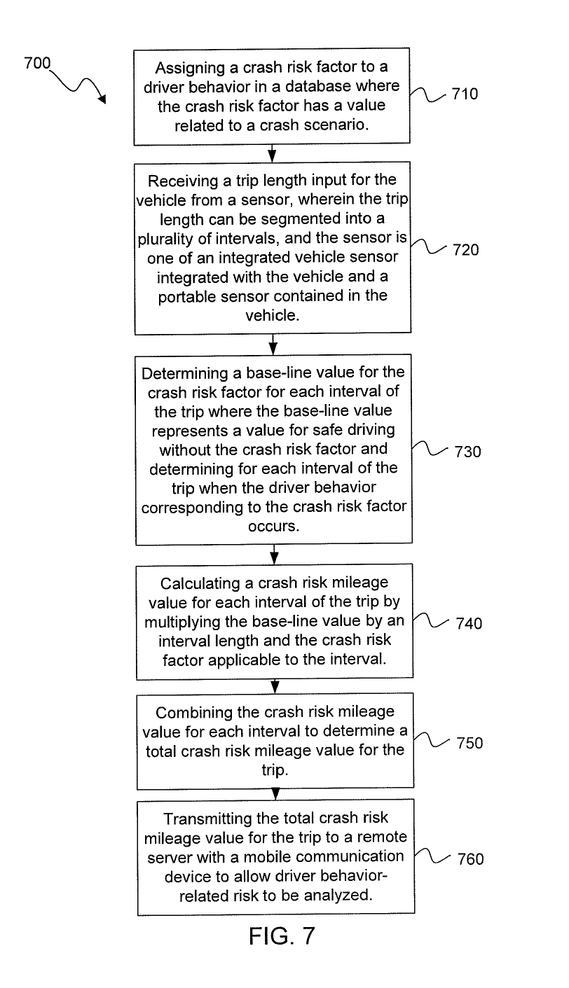

Another embodiment provides a method 700 for quantifying driver behavior-related crash risk for a trip in a vehicle, as shown in the flow chart in FIG. 7. The method includes the operation of assigning 710 a crash risk factor to a driver behavior in a database where the crash risk factor has a value related to a crash scenario. The operation of receiving 720 a trip length input for the vehicle from a sensor, wherein the trip length can be segmented into a plurality of intervals, and the sensor is one of an integrated vehicle sensor integrated with the vehicle and a portable sensor contained in the vehicle follows. The next operation of the method can be determining 730 a base-line value for the crash risk factor for each interval of the trip where the base-line value represents a value for safe driving without the crash risk factor and determining for each interval of the trip when the driver behavior corresponding to the crash risk factor occurs.

The method 700 further includes calculating 740 a crash risk mileage value for each interval of the trip by multiplying the base-line value by an interval length and the crash risk factor applicable to the interval. Next, the operation of combining 750 the crash risk mileage value for each interval to determine a total crash risk mileage value for the trip can be performed. This combining step can be a composite calculated via addition, weighting, or other multipliers based on the most suitable format for representing the information in a particular scenario. The operation of transmitting 760 the total crash risk mileage value for the trip to a remote server with a mobile communication device to allow driver behavior-related risk to be analyzed follows.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

What is claimed is:

1. A method for quantifying driver behavior-related crash risk for a trip in a vehicle, comprising:
assigning a crash risk factor to a driver behavior in a database where the crash risk factor corresponds to a crash scenario;
receiving a trip length for the vehicle from a sensor, wherein the trip length can be segmented into a plurality of intervals, and the sensor is one of an integrated vehicle sensor integrated with the vehicle and a portable sensor contained in the vehicle;
determining a base-line value for the crash risk factor for each interval of the trip where the base-line value represents a value for safe driving without the crash risk factor and determining for each interval of the trip when the driver behavior corresponding to the crash risk factor occurs;
calculating a crash risk mileage value for each interval of the trip by multiplying the base-line value by an interval length and the crash risk factor applicable to the interval;
combining the crash risk mileage value for each interval to determine a total crash risk mileage value for the trip; and
transmitting at least one of the total crash risk mileage value for the trip and the driver behavior to a remote server with a mobile communication device to allow driver behavior-related risk to be analyzed.

2. The method of claim 1, wherein the crash scenario is a crash type or a crash severity.

3. The method of claim 1, wherein the trip length is a distance traveled for the trip or a time duration for the trip, and the interval is a distance segment of the trip or a time segment of the trip.

4. The method of claim 1, further comprising assigning a plurality of crash risk factors to a corresponding plurality of driver behaviors, wherein the crash risk mileage value for each interval of the trip includes a composite value including all of the plurality of crash risk factors for the interval.

5. The method of claim 1, further comprising assigning a combined crash risk factor for a plurality of driving behaviors occurring in a common interval and the combined crash risk factor is used to calculate the crash risk mileage value for the common interval when the plurality of driving behaviors are applicable to the common interval.

6. A method of claim 1, further comprising generating a driving score from the crash risk mileage value.

7. The method of claim 1, further comprising:
generating a crash risk interval score for each interval from the crash risk mileage value for a corresponding interval;
combining the crash risk interval score for each interval to determine a total crash risk trip score; and
transmitting the total crash risk trip score to the remote server.

8. The method of claim 1, wherein the crash risk factor for the driver behavior is selected from the group consisting of a speed of the vehicle relative to a local speed limit, a seatbelt status identifying whether at least one of a driver and all occupants of the vehicle are wearing their seatbelts, and a mobile communication device in-use status when the mobile communication device is used by the driver while the vehicle is moving.

9. The method of claim 8, further comprising recalculating the crash risk factor based on collected driver behavior data, reported collisions, risk factors reported in research literature, or combination thereof.

10. The method of claim 1, further comprising determining the driver behavior of speeding by comparing a speed of the vehicle with a record of a speed limit at a location of the vehicle to determine if the vehicle is speeding during the trip.

11. The method of claim 1, further comprising receiving input from the sensor to determine when the crash risk factor is applicable based on a sensor reading received from the sensor.

12. The method of claim 1, further comprising receiving input from a plurality of sensors in the vehicle.

13. The method of claim 1, wherein receiving the trip length further comprises receiving a trip length input by an interval traveled module from the sensor.

14. The method of claim 1, wherein the trip length is a distance traveled for the trip, the interval is a distance segment of the trip, and receiving the trip length by a distance traveled module receives an input from a global positioning satellite receiver to determine the distance traveled.

15. A method for quantifying driver behavior-related crash risk for specific crash severities for a trip in a vehicle, comprising:
assigning a severity-specific crash risk factor to a driver behavior in a database where the severity-specific crash risk factor corresponds to a crash severity and assigning a crash risk factor to the driver behavior in the database where the crash risk factor corresponds to a crash type;
receiving a trip length for the vehicle from a sensor, wherein the trip length can be segmented into a plurality of intervals, and the sensor is one of an integrated vehicle sensor integrated with the vehicle and a portable sensor contained in the vehicle;
determining a base-line value for the crash risk factor for each interval of the trip where the base-line value represents a value for safe driving without the crash risk factor and determining for each interval of the trip when the driver behavior corresponding to the crash risk factor occurs;
calculating a severity-specific crash risk mileage value for each interval of the trip by multiplying the assigned severity-specific crash risk factor for the driver behavior affecting each crash severity with the base-line value and the crash risk factor associated with the driver behavior and the interval traveled for which the respective crash risk factor is applicable;
adding the severity-specific crash risk mileage value for each interval to determine a total severity-specific crash risk mileage value for the trip; and
transmitting at least one of the total severity-specific crash risk mileage value and the driver behavior for the trip to a remote server with a mobile communication device.

16. A method of claim 15, further comprising generating a driving score derived from a score value selected from the group consisting of the severity-specific crash risk mileage value, the total severity-specific crash risk mileage value, and combinations thereof; where the driving score allows an analysis of the driver's risk exposure, an adjustment in insurance cost to account for driving habits, a determination of commuting distances and practice requirements; and the driving score is capable of being shared with the driver and other interested parties.

17. The method of claim 15, further comprising:
calculating a crash risk mileage value for each interval of the trip by multiplying the base-line value by the interval and the crash risk factor applicable to the interval;
combining the crash risk mileage value for each interval to determine a total crash risk mileage value for the trip; and
transmitting the total crash risk mileage value for the trip to the remote server with the mobile communication device to enable driver behavior-related risk to be analyzed.

18. A method as in claim 17, further comprising calculating a cost to insure a driver using a cost value selected from the group consisting of the total severity-specific crash risk mileage value, the total crash risk mileage value, and combination thereof, where the cost value is calibrated in reference to an average driver's behavior.

19. A method as in claim 18, wherein calculating the cost calibrates the cost value for an average driver based upon estimates of the average driver's behavior.

20. A method as in claim 17, further comprising calculating a driving score using a score value selected from the group consisting of the total severity-specific crash risk mileage value, the total crash risk mileage value, and combination thereof, where the score value is calibrated in reference to an average driver's behavior.

21. The method of claim 20, further comprising sharing the driving score as a measure of the driver behavior-related crash risk with an interested party.

22. The method of claim 21, wherein the interested party is selected from the group consisting of the driver, a vehicle owner, an underwriter, and an insurance company.

23. The method of claim 21, wherein sharing the driving score is sent via an electronic communication to the interested party and viewable on a display.

24. The method of claim 17, further comprising saving a saved value selected from the group consisting of the total severity-specific crash risk mileage value, the total crash risk mileage value, the severity-specific crash risk mileage value for each interval, the crash risk mileage value for each interval, and combination thereof in a history database to allow examination of a driving behavior history data by interested parties.

25. The method of claim 24, further comprising at least one of sending the saved value to the driver allowing for driving behavior feedback, encouraging improved driving behavior and allowing for an investigation of relationship between driver insurance premiums and driving behavior, and allowing for communication of the driving behavior history data associated with the saved value between multiple insurance companies, and allowing for use of the driving behavior history data to negotiate vehicle insurance premiums with a plurality of insurance policy providers.

26. The method of claim 24, wherein the history database is on a server which is accessible to an insurance underwriter for assessing the saved value or adjusting an insurance rate on the driver based on the saved value.

27. The method of claim 20, further comprising classifying the driving score into an actuarial category for determining an insurance premium rate for the driver where the driving score is a component of the actuarial category.

28. A system for quantifying driver behavior-related risk for a trip in a vehicle, comprising:
a data collection device configured to receive a trip length and to determine an occurrence of a driver behavior for each interval of the trip from at least one of an integrated vehicle sensor integrated with the vehicle and a portable sensor contained in the vehicle during the trip, wherein the trip length can be segmented into a plurality of intervals;
a storage module for storing a crash risk factor assigned to the driver behavior for the occurrence of the driver behavior in each interval of the trip, where the crash risk factor corresponding to a crash scenario; and
a crash risk analysis module configured to determine a base-line value for the crash risk factor for each interval of the trip where the base-line value represents a value for safe driving without the crash risk factor, and configured to calculate a crash risk mileage value for each interval of the trip by multiplying the base-line value by an interval length and the crash risk factor applicable to the interval, and configured to add the crash risk mileage value for each interval to determine a total crash risk mileage value for the trip.

29. The system of claim 28, further comprising a transmitter for transmitting the total crash risk mileage value for the trip to a remote server with a mobile communication device, wherein the mobile communication device is integrated with the portable sensor contained in the vehicle.
